(19) United States
(12) Patent Application Publication
(10) Pub. No.: US 2025/0374903 A1
(43) Pub. Date: Dec. 11, 2025

(54) High-Strength Fishing Rod With A Carbon Fiber Cross Structure

(71) Applicant: Weihai E-max Sport Apparatus Co., LTD, Weihai City (CN)

(72) Inventors: Sun Xiantao, Weihai City (CN); Chen Ming, Weihai City (CN); Wang Minjin, Weihai City (CN)

(73) Assignee: Weihai E-max Sport Apparatus Co., LTD, Weihai City (CN)

(21) Appl. No.: 18/738,573

(22) Filed: Jun. 10, 2024

(51) Int. Cl. A01K 87/00; B32B 1/00; B32B 5/12; B32B 37/18; B32B 38/00

(52) U.S. Cl. CPC A01K 87/00; B32B 1/00; B32B 5/12; B32B 37/18; B32B 38/0004; B32B 2260/023; B32B 2260/046; B32B 2262/106; B32B 2305/076; B32B 2309/02; B32B 2309/12; B32B 2313/04

(57) ABSTRACT

Disclosed is a high-strength fishing rod body having carbon fibers oriented at an intersecting angle. The rod body is a tapering cylindrical tube having an extended axis. The rod body is formed by a multi-layer structural fiber cloth layer rolled at least once and having one or more layers of a first carbon fiber prepreg cloth comprising carbon fibers oriented at a first angle relative to the rod axis and one or more layers of a second carbon fiber prepreg cloth layers having second carbon fibers oriented at a second angle relative to the rod axis. When wrapped about a forming mandrel, the carbon fiber direction of the first carbon fiber prepreg cloth layer forms a first angle with the radial direction of the rod body, the carbon fiber direction of the second carbon fiber prepreg cloth layer forms a second angle with the radial direction of the rod body, and the first angle and the second angle are symmetrical along the radial direction of the rod body. Compared with the fishing rod body obtained by rolling in an ordinary single fiber direction, the high-strength fishing rod body with a carbon cloth cross structure can obtain a bidirectional cross spiral structure with a larger angle, thereby greatly enhancing the strength of the fishing rod.

### FIELD OF THE INVENTION

The technical field of fishing rod production and processing and specifically relates to a high-strength fishing rod with a carbon fiber structure in which the fibers cross and are disposed at various angles.

### BACKGROUND OF THE INVENTION

With the increasing living standards of our people, relying on traditional fisheries and for the purpose of entertainment and leisure, recreational fishing has become an emerging industry developed to meet the material and cultural consumption needs of the people. Fishing has gradually become a favorite entertainment and leisure activity for people. As an indispensable tool for fishing, the performance of fishing rods affects the performance and experience of fishing techniques.

Currently, widely used fishing rods can be distinguished from fiberglass rods and carbon fiber rods in terms of materials. Fiberglass rods are fishing rods made of fiberglass and resin. This kind of fishing rod is strong and durable, retractable, easy to use, can withstand strong pulling force, is not conductive, and is cheaper than carbon fiber rods; however, compared with carbon fiber rods, glass fiber rods of the same length are much heavier than carbon fiber rods, has certain defects.

The main component of the carbon fiber rod material is carbon fiber. The characteristic of the carbon fiber rod is that it is light. Its weight is about half that of the glass fiber rod. The carbon cloth fibers of the carbon fiber rod are distributed in parallel radial directions. The mold has a certain taper and is spirally distributed at a small angle, and the spiral direction is in one direction, which puts a certain limit on the strength of the fishing rod and makes it easy to break.

Carbon fibers are commercially available in a wide variety of forms and strength grades. For fishing rod manufacture, the most convenient form is a roll of carbon fibers that are pre-impregnated (“prepreg”) with a curable resin. Discrete sheets of a desired size and shape can be cut from these rolls to make sheets of oriented carbon fibers that can be combined with a curable resin system and rolled into a fishing rod blank. With conventional surface finishing, a rod blank can be combined with a plurality of line guides, a handle, and reel seat components to make a useful fishing rod in any of a number of configurations to meet the varying needs of the angling community.

Carbon fibers are generally of high tensile strength along the extended axis of the fiber and less so transverse or at an angle to that axis. Thus, the strength and resilience of fishing rods made from a carbon fiber composite are affected by the orientation of the carbon fibers relative to the extended axis of the rod as well as the modulus of fibers used in the composite.

Various inventors have disclosed processes for combining carbon fibers in various ways to make a distinctive fishing rod. See, e.g., U.S. Pat. No. 5,231,783 that also uses a wound tape with attention to the fiber orientation; U.S. Pat. No. 6,106,413 that describes the use of discrete pieces at various locations along the mandrel for strength enhancement; and U.S. Pat. No. 10,272,302 teaching the use of wound carbon fiber tape.

Despite these advances, there remains room for improvements in the manufacturing process for even greater control over the specific angular dispositions of the carbon fibers in the rod blank.

### SUMMARY OF THE INVENTION

It is an object of the invention to provide a fishing rod and method of its manufacture that enhances the overall strength of the fishing rod.

It is further an object of the invention to provide a manufacturing method that allows the maker a greater degree of control over the angular disposition of carbon fibers within the final fishing rod.

It is also an object of the invention to provide a method of making a high-strength fishing rod having oppositely wrapped, helically-oriented, carbon fibers that form a structure in which the carbon fibers are wrapped to intersect in an opposing pattern of angles.

In accordance with these and other objects of the invention that will become apparent from the description herein, a fishing rod according to the invention comprises a carbon cloth cross structure having generally tapering, cylindrical rod body in which a diameter of the rod body gradually decreases from butt to tip along a rod axis, and is characterized in that the rod body is surrounded by one or more layers of a first carbon fiber prepreg layers having carbon fibers oriented at a first angle to said rod axis, and one or more second carbon fiber prepreg layers having carbon fibers oriented at a non-zero angle to said first angle. Preferably, the direction of the first carbon fibers in the first prepreg layer is substantially constant along the rod axis along the length of the rod body, and the carbon fiber direction of the second carbon fiber prepreg layer forms a substantially constant crossing angle with the carbon fibers of the immediately previous layer of carbon fibers along the length of the rod body. The use of carbon fiber layers that are not parallel and that cross at a relative crossing angle within the range of 30°-150° allow the strength of the carbon fibers to be realized and form a stronger fishing rod.

The manufacturing process to make such a rod comprises the following steps: (a) forming a first composite by laminating two rectangular sheets of carbon fiber prepreg under suitable heat and pressure wherein the fibers of each sheet are disposed within each sheet at an angle of about 90° relative to the fibers of the other sheet; (b) cutting the first composite sheet at a diagonal angle to produce first and second sheets of first composite having a longer terminal end, a shorter terminal end, an uncut long side, and a cut diagonal side; (c) combining the first sheet of first composite with a first trapezoid-shaped sheet of axial prepreg having an uncut long side and a diagonally cut long side wherein carbon fibers in said axial prepreg are oriented axially and parallel to a winding axis to make a second composite having an uncut long side, wherein the uncut long side of the first sheet of first composite is parallel to the uncut long side of the trapezoid-shaped sheet of axial prepreg; (d) combining the second sheet of first composite with a second trapezoid-shaped sheet of axial prepreg having an uncut long side and a diagonally cut long side wherein carbon fibers in said axial prepreg are oriented axially and parallel to a winding axis to make a third composite having a diagonally cut long side, wherein the diagonally cut long side of the second sheet of first composite is parallel to the diagonally long side of the trapezoid-shaped sheet of axial prepreg; (e) and simultaneously or in serial, attaching the uncut long side of the second composite to a fishing rod mandrel and winding said second composite onto said mandrel; and attaching the diagonally cut long side of the third composite to said fishing rod and winding said third composite onto said mandrel; and (f) curing the composites on said mandrel under suitable heat and pressure.

### BRIEF DESCRIPTION OF DRAWINGS

FIGS. 1-4 are a diagram showing the manufacturing process of the invention in which carbon fiber prepreg oriented at opposing, mirror image angles (FIG. 1) are laminated (FIG. 2) to make a first composite with fibers that cross the fibers of the adjacent layer (FIG. 3) which is then cut at an angle to make two right trapezoid shapes having long and short ends, a straight side, and a diagonal side. One of those shapes is rotated 180° relative to the other for further processing (FIG. 4).

FIG. 5 shows the lamination of the first sheet of the first right trapezoid composite with a third right trapezoid sheet of axial fiber prepreg cut to be rolled onto a tapered rob blank mandrel to make a second composite. The axial fiber prepreg has carbon fibers that are oriented parallel to the straight side of the sheet and with the axis of the rod blank mandrel.

FIG. 6 shows the same process depicted in FIG. 5 but with the other sheet of the first right trapezoid composite formed in FIG. 4 to make a third composite.

FIG. 7 shows the orientation of the second and third composites as they are attached to the rod blank mandrel.

### DETAILED DESCRIPTION OF THE INVENTION

In order to solve the above-mentioned problems, the present invention proposes a high-strength fishing rod with a carbon cloth cross structure. Compared with common carbon fiber fishing rods, the strength of the high-strength fishing rod is further improved, thereby improving the performance of the fishing rod.

In accordance with the above, the present invention adopts the following technical solutions:

A high-strength fishing rod with a carbon cloth cross structure includes a cylindrical rod body, the diameter of which gradually decreases along the length direction. The rod body is made of a multi-layer structural fiber cloth layer rolled around at least once. The multi-layer structural fiber cloth layer includes at least one first carbon fiber prepreg cloth layer and at least one second carbon fiber prepreg cloth layers. The carbon fiber direction of the first carbon fiber prepreg layer forms a first angle relative to the extended axis of the rod body and mandrel around which the layer will be wound. The carbon fiber direction of the second carbon fiber prepreg layer forms a second angle relative to the extended axis of the rod body and mandrel around which the layer will be wound. The first angle and the second angle are preferably independently selected to have opposing angles within a range from about 10°-170° relative to the rod body axis such that, when both the first and second layers are wound around the tapered mandrel, the carbon fibers of successive layers cross at an angle within a range from about 15-80° relative to the other layer.

A manufacturing process for making a high-strength, fishing rod body by winding carbon fiber prepreg and a curable resin around a tapered rod blank mandrel having a winding axis, said according to the invention comprises:
laminating a first sheet of prepreg having carbon fibers oriented at a first angle relative to a winding axis to a second sheet of prepreg having carbon fibers oriented at a second angle relative to said winding axis to make a first composite of extended length having longer lateral side and shorter terminal end sides, wherein said composite has carbon fibers from the first sheet or prepreg and the second sheet of prepreg that cross in said first composite at a third angle relative to said winding axis;
cutting said first composite from one terminal end side to the other terminal end side at a fourth angle relative to a lateral side to form: (a) a first sheet of said first composite, and (b) a second sheet of said first composite, wherein the first sheet and the second sheet each have a short terminal end side and a longer terminal end side;
laminating said first sheet of said first composite to a third sheet of prepreg having carbon fibers oriented parallel to said winding axis to form a second composite;
laminating said second sheet of said first composite to a fourth sheet of prepreg having carbon fibers oriented parallel to said winding axis to form a third composite;
attaching said second composite and said third composite to the tapered rod mandrel;
rolling the composites onto said mandrel to make an uncured blank; and
curing the blank under pressure and with heat to make a fishing rod blank.

The invention also contemplates a fishing rod made according to the process described above and comprising carbon fibers oriented, relative to a winding axis of said fishing rod, (a) substantially axially as well as (b) within a range from about +45-55° and (c) within a range from about +225-235°.

Preferably, the multi-layer structural fiber cloth layer includes a first carbon fiber prepreg cloth layer and two second carbon fiber prepreg cloth layers, and the first carbon fiber prepreg cloth layer is arranged between two layers of the second carbon fiber prepreg cloth. between layers of prepreg.

Preferably, the multi-layer structural fiber cloth layer includes two first carbon fiber prepreg cloth layers and one second carbon fiber prepreg cloth layer, and the second carbon fiber prepreg cloth layer is arranged between two sheets of the first carbon fiber prepreg cloth layer. between layers of prepreg.

Preferably, an adhesive layer is provided between the first carbon fiber prepreg layer and the second carbon fiber prepreg layer, and the adhesive layer connects the first carbon fiber prepreg layer and the second carbon fiber prepreg layer. When heated and cured, the second carbon fiber prepreg layer becomes permanently fixed as an integral body to the layers immediately above and below.

In some embodiments, a fishing rod body is formed from a series of sections that fit together, one into a socket formed in the other, successively to form a continuously tapering fishing rod of a designated length. Such a structure allows very long fishing rods to be made and transported conveniently.

Preferably, the fishing rod body is fitted with a series of line guide rings secured to the outer surface of the rod body at designated intervals and aligned to guide fishing line smoothly from a reel mounted on a handle located at the butt end of the rod body.

The beneficial effects of the present invention are: the present invention obtains a multi-layer structural fiber cloth layer by combining the first carbon fiber prepreg layer and the second carbon fiber prepreg layer with different carbon fiber directions, and rolls the multi-layer structural fiber cloth layer The fishing rod body is obtained such that the carbon fiber directions of the first carbon fiber prepreg layer and the second carbon fiber prepreg layer respectively form a symmetrical first angle and a second angle with the radial direction of the rod body. Compared with ordinary single fiber Moving towards the rolled fishing rod body, the rod body of the high-strength fishing rod with the carbon cloth cross structure can obtain a larger angle bidirectional cross spiral structure. The cross spiral carbon fiber structure is stronger than the unidirectional small angle spiral carbon fiber structure, thereby greatly enhancing the strength of the fishing rod.

Resins useful for the present invention include the conventional resins that can be cured with heat, that that are compatible with the resin of the prepreg, and which impart toughness to the final rod structure while retaining flexibility. Such compositions are often based on epoxy, acrylics, and mixtures thereof. See generally, US Publication Number 2023/0383077 and U.S. Pat. Nos. 3,953,637; 4,003,778; 8,697,811; 10,875,976; and 11,161,975, the disclosures of which are hereby incorporated by reference.

In order to enable those skilled in the art to better understand the solution of the present invention, the invention will be further described in detail below in conjunction with the accompanying drawings. The described embodiments are only some, not all, of the embodiments of the present invention. Based on the embodiments of the present invention, all other embodiments obtained by those of ordinary skill in the art without creative efforts fall within the scope of protection of the present invention.

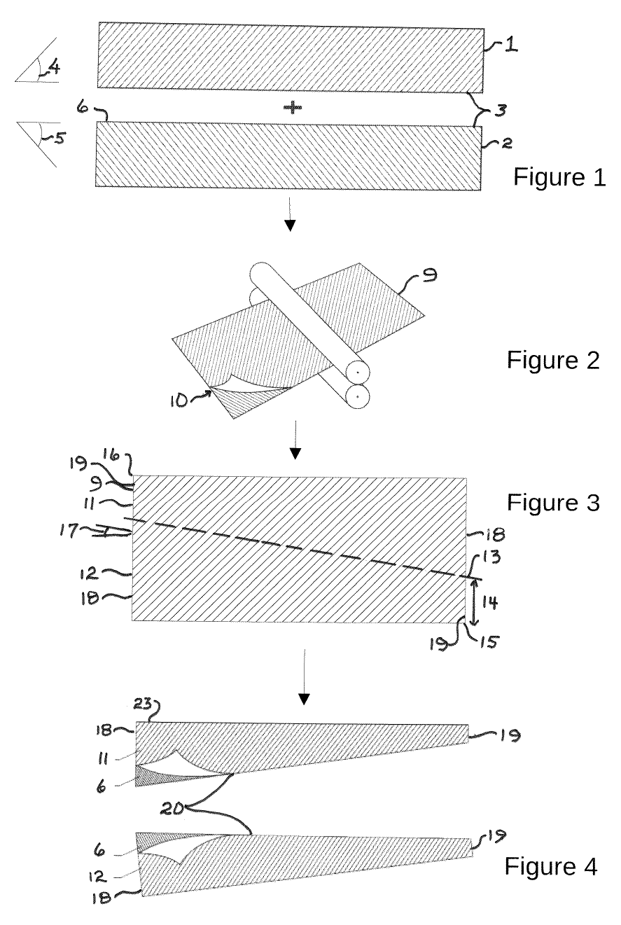

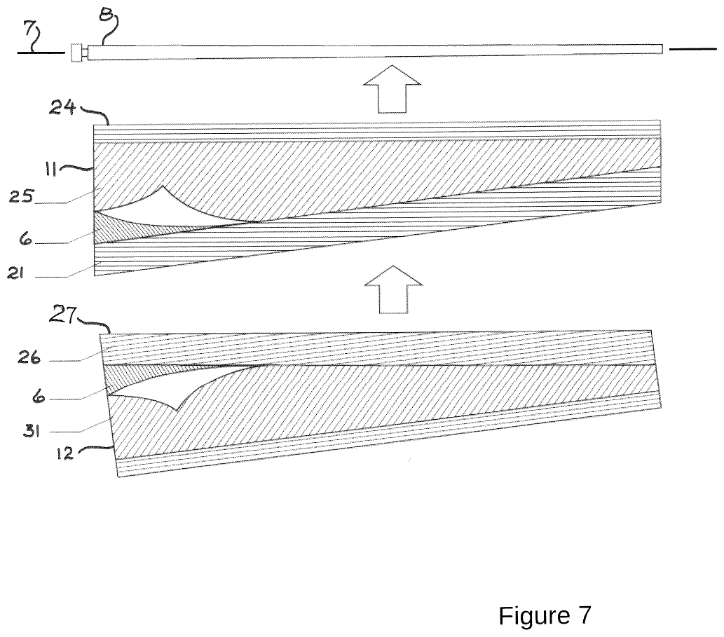

As shown in FIG. 1, the first step of the manufacturing process starts with 1^{st} rectangular sheet 1 and 2^{nd} rectangular sheet 2. Each of these sheets is prepreg having carbon fibers 3 oriented at a first angle 4 of about +45 (in sheet 1) and a second angle 5 of about +225 degrees (in sheet 2) relative to the edge 6 of the rectangular sheets that corresponds to winding axis 7 of tapered rod blank mandrel 8 (see FIG. 7).

These sheets 1, 2 are laminated together with heat and pressure to produce a first composite 9 having fibers 3 oriented at roughly right angles 10, e.g., fibers 3 at angle 4 crossing fibers 3 at angle 5.

A suitable temperature for making this 1^{st} composite 19 is generally within a range from about 45-60° C., preferably 50-55° C. with a pressure in a range from about 0.5-1 MPa, preferably 0.7-0.8 MPa.

The second step of the process (FIG. 3) cuts the first composite 9 along its length but at a diagonal 13 spaced a distance 14 from each of terminal edges 15, 16 to produce a first trapezoidal sheet 11 and a second trapezoidal sheet 12. The specific angle 17 of diagonal 13 will depend on the length of the rod to be made and the desired thickness, as one skilled in this art will be able to determine in advance of manufacture, typically an angle within a range from about 1-10 degrees, preferably a range within about 1.5-3 degrees relative to winding axis 7 of mandrel 8. Such a diagonal cut will produce a pair of trapezoidal sheets having a longer terminal end 18 and a shorter terminal end 19 with a straight side that is at right angles to each of the terminal ends 18, 19 and a diagonal edge 20.

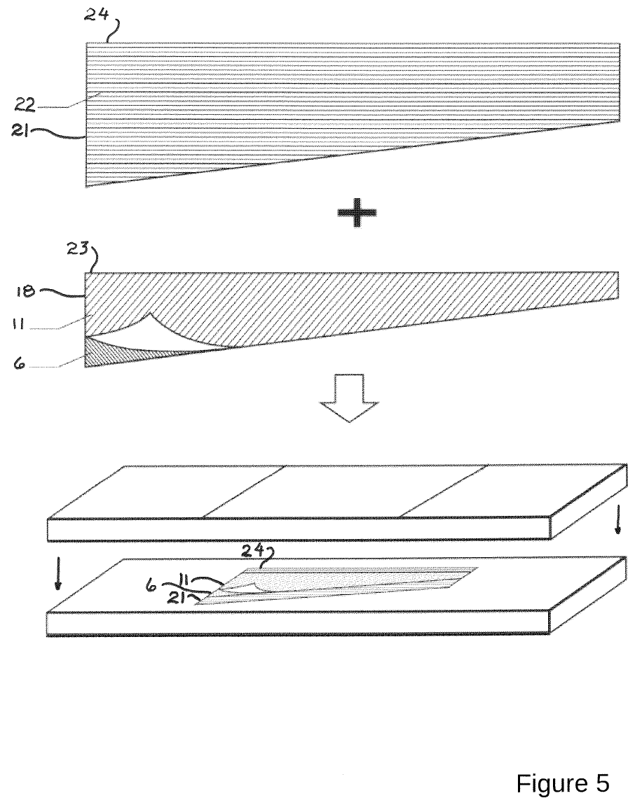

The third step of the manufacturing process rotates trapezoidal sheet 12 by about 180° relative to sheet 11 so the longer and shorter terminal ends 18, 19 are aligned (FIG. 4). As shown in FIG. 5, Sheets 11, 12 are then combined under heat and pressure with a trapezoidally-shaped layer of prepreg 21 having carbon fibers 22 oriented substantially parallel to winding axis 7. First sheet 11 is positioned centrally within axial prepreg sheet 21 so that the uncut first edge 24 and uncut second edge 23 are positioned in parallel but offset on the same side. The resulting stack is laminated to form 2nd composite 25 of three layers, having fibers oriented axially (about 0 degrees from sheet 21) as well as crossing (+45, +225 degrees from sheet 11 of 1^{st} composite 9).

A suitable temperature for making this 2nd composite 25 is generally within a range from about 25-35° C., preferably 28-32° C. with a pressure in a range from about 0.1-0.5 Mpa, preferably 0.2-0.3 MPa.

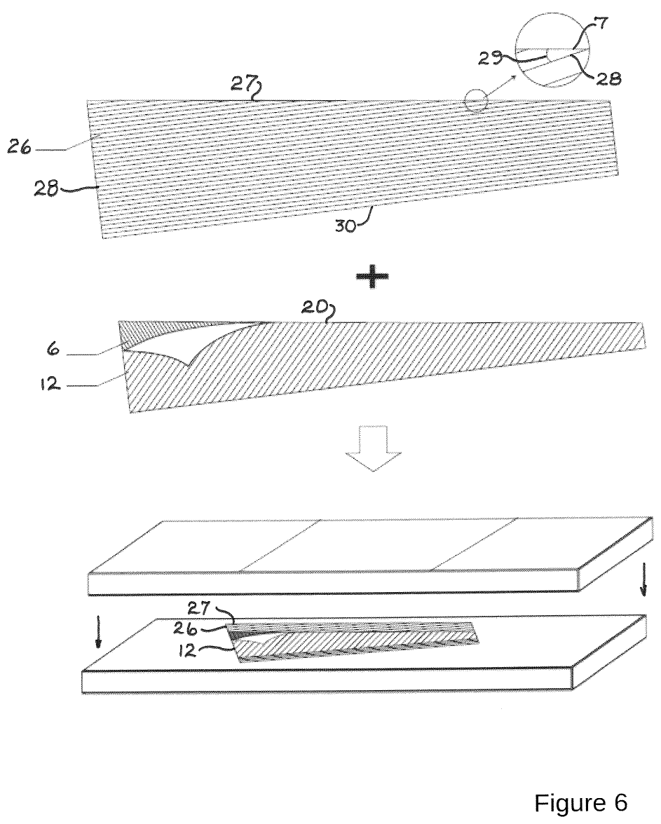

As shown in FIG. 6, axial prepreg sheet 26 presents carbon fibers 28 parallel to uncut long edge 30 and at second angle 29 relative to winding axis 7. Sheet 12 is positioned within sheet 26 so that their respective diagonal edges 20 (sheet 12) and 27 (sheet 26) and offset from the long edges 27, 30 of sheet 26. The sheets are then laminated under heat and pressure to form 3^{rd} composite 31.

A suitable temperature for making this 3^{rd} composite 31 is generally within a range from about 25-35° C., preferably 28-32° C. with a pressure in a range from about 0.1-0.5 MPa, preferably 0.2-0.3 MPa.

As shown in FIG. 6, 2^{nd} composite 25 and 3^{rd} composite 31 are both wound onto mandrel 8 so that the axially-oriented carbon fibers in sheets 21, 26 remain substantially parallel to winding axis 7. Second composite 25 is attached to mandrel 8 along uncut first edge 24. Third composite 31 is attached to mandrel 8 along diagonal cut 27 so that carbon fibers in axial prepreg sheet 21 are substantially parallel to carbon fibers in axial prepreg sheet 26 (FIG. 7).

The short terminal end of each composite provide for a rod blank having a desired degree of uniform prepreg thickness along the length of the rod blank. The differing angles of fiber orientations in sheets 1, 2 that make up 1^{st} composite 9 will present carbon fibers within the final rod blank that are axial (substantially 0 degrees) as well as within about +45-55°, and about +225-235° relative to the winding axis of the rod blank. Some rods may best use a different range of angles that can be accomplished using the process of the present invention with intermediate prepreg layers having carbon fibers oriented at the desired degree of angular orientation relative to the winding axis 7 of mandrel 8. This wide variety of angular presentations provides a fishing rod that shows strength and durability across a wide range of angles.

The preferred embodiments of the present invention disclosed above are only used to help explain the present invention and are not limited to the specific implementation modes described. For example, a particular fishing rod may have design requirements that uses more than one layer of each sheet of prepreg or multiple layers of the 1^{st}-3^{rd} composites.

The embodiments selected and specifically described in this specification are used to better explain the principles and practical applications of the present invention, so that those skilled in the art can better understand and utilize the present invention and are not intended to limit the claimed invention.

1. A process for making a high-strength, fishing rod body by winding carbon fiber prepreg around a tapered rod blank mandrel having a winding axis, said process comprising:
laminating a first sheet of prepreg having carbon fibers oriented at a first angle relative to a winding axis to a second sheet of prepreg having carbon fibers oriented at a second angle relative to said winding axis to make a first composite of extended length having longer lateral side and shorter terminal end sides, wherein said composite has carbon fibers from the first sheet or prepreg and the second sheet of prepreg that cross in said first composite at a third angle relative to said winding axis;
cutting said first composite from one terminal end side to the other terminal end side at a fourth angle relative to a lateral side to form: (a) a first sheet of said first composite, and (b) a second sheet of said first composite, wherein the first sheet and the second sheet each have a short terminal end side and a longer terminal end side;
combining said first sheet of said first composite to a third sheet of prepreg having carbon fibers oriented parallel to said winding axis to form a second composite;
joining said second sheet of said first composite to a fourth sheet of prepreg having carbon fibers oriented parallel to said winding axis to form a third composite;
attaching said second composite and said third composite to the tapered rod mandrel;
rolling the composites onto said mandrel to make an uncured blank, and
curing the blank under pressure and with heat to make a fishing rod blank.

2. A process according to claim 1 wherein the first sheet of prepreg has carbon fibers oriented at said first angle of about +45 relative to said winding axis.

3. A process according to claim 1 wherein the second sheet of prepreg has carbon fibers at said second angle of about +225 degrees relative to said winding axis.

4. A process according to claim 1 wherein the laminating step comprises combining the first sheet of prepreg and the second sheet of prepreg at a temperature within a range from about 45-60° C. with a pressure in a range from about 0.5-1 Mpa to form a first composite.

5. A process according to claim 4 wherein the cutting step comprises cutting said first composite along its length but at a diagonal spaced a distance from each terminal edge to produce a first trapezoidal sheet and a second trapezoidal sheet, each trapezoidal sheet having a diagonal edge, a longer terminal end, a shorter terminal end and an uncut edge at right angles to each terminal end.

6. A process according to claim 4 wherein the cutting is at an angle within a range from about an angle within a range from about 1-10 degrees relative to said winding axis.

7. A process according to claim 6 wherein the cutting is at an angle within a range from about an angle within a range from about 1-10 degrees relative to said winding axis.

8. A process according to claim 5 further comprising rotating the second trapezoidal sheet by about 180° relative to the first trapezoidal sheet so the longer and shorter terminal ends of each trapezoidal sheet are aligned.

9. A process according to claim 6 wherein the joining step to make said third composite occurs at a temperature within a range from about 25-35° C. and a pressure in a range from about 0.1-0.5 MPa.

10. A process according to claim 1 wherein said fishing rod body has carbon fibers oriented, relative to said winding axis, that are substantially axial as well as within a range from about +45-55° and within a range from about +225-235°.

11. A fishing rod made according to the process of claim 1.

12. A fishing rod comprising carbon fibers oriented, relative to a winding axis of said fishing rod, (a) substantially axially as well as (b) within a range from about +45-55° and (c) within a range from about +225-235°.
